(19) United States
(12) Patent Application Publication
(10) Pub. No.: US 2005/0080770 A1
(43) Pub. Date: Apr. 14, 2005

(54) System and process for presenting search results in a tree format

(75) Inventors: Roger Allen Lueder, San Francisco, CA (US); David James Gemmell, Danville, CA (US); Chester Gordon Bell, San Francisco, CA (US)

Correspondence Address: LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 10/684,775

(22) Filed: Oct. 14, 2003

(51) Int. Cl. G06F 17/30

(52) U.S. Cl. 707/3; 707/102; 707/7

(57) ABSTRACT

A system and process for graphically displaying the results of a standard electronic search to a user on a display device via an interactive search results window in which the user views and refines search results items using a tree format. In general, the tree has a first level that indicates how the search results may be refined. The second level of the tree shows what subsets (what) are available for a particular refining method. The third level shows how the already refined (by the second level) results may be refined further. This is repeatedly applied with odd-numbered levels of the tree indicating how the results may be refined, and even-numbered levels indicating what subsets are available. In addition to the tree, the search results window also includes a listing of the search results items associated with a user-selected portion of the tree.

### BACKGROUND

1. Technical Field:

The invention is related to displaying the results of an electronic search, such as a database search, to a user, and more particularly to a system and process for graphically displaying the results of a search to a user on a display via an interactive search results window having a tree format in which the user views and refines the search results.

2. Background Art:

The personal computer will eventually have extremely large amounts of storage capacity, resulting in large data stores. In addition, information spaces reachable via computer networks, such as the Internet, provide a user access to vast amounts of data. Typically, the user will be interested in retrieving specific information of interest from these sources of data. This task is handled using a search engine, which typically employs keywords in an attempt to find items of interest within the data sources. The search results are usually presented to the use in the form of a list. However, when the data sources are large, the results of a search can produce an unmanageable number of items. These large search results sets are difficult to analyze effectively to find the information the user is seeking. Thus, better ways of visualizing and navigating the results of an electronic search are needed. The present invention provides such techniques.

### SUMMARY

The present invention is directed toward a user interface system and process for graphically displaying the results of an electronic search to a user on a display device via a search results window in a tree format. A search results tree allows the user to easily browse through and refine (i.e., reduce to a smaller sets) the results. In general, the tree has a first level that indicates how the search results may be refined. The second level of the tree shows what subsets (what) are available for a particular refining method. The third level shows how the already refined (by the second level) results may be refined further. This is repeatedly applied with odd-numbered levels of the tree indicating how the results may be filtered, and even-numbered levels indicating what sub-sets are available.

More particularly, the foregoing involves including a graphic data presentation sector in the search results window that displays the aforementioned multi-leveled tree. Initially only a top level of the tree is displayed. This top level includes categories representing how the search results can be grouped. In response to a user command to do so, a second level of the tree for one or more of the top level categories can be displayed as well. The second level includes one or more subsets representing the search results as grouped using the top level category and divided into smaller groups. The categories are based on known attributes of the search results. For example, the attributes can include the date a search results item was created, the date a search results item was last modified, the name of the search results item, or the file size of a search results item. These attributes generally relate to search results characteristics that range. In such cases, the second level subsets are created by clustering the top level category search results into a series of ranges. For example, if the top level category involved categorizing the search results according to a date, they would be clustered into a series of date ranges. If the top level category involved categorizing the search results according to names, they would be clustered into a series of alphanumeric ranges based on a first symbol of the name of the search results item. Still further, if the top level category involved categorizing the search results according to file size, they would be clustered into a series of size ranges.

A top level category can also be included that represents the grouping of the search results by types, where each search result item applicable to this category is one of a predefined set of said types. In this case, the second level of the tree has one or more subsets representing the search results grouped into the type classifications.

Additional lower levels of the tree can also be displayed in response to a user command to do so. In general, whenever the immediately preceding level of a branch of the tree involves search result items clustered into a series of ranges, a new level depending from one of these ranges will provide ways in which the search results associated with that range can be grouped. Conversely, whenever the immediately preceding level of a branch of the tree provides ways in which the search results associated with that branch can be grouped, a new level depending from one of these ways have the search result items clustered into a series of subset ranges appropriate to the grouping.

In addition to the presentation sector, a list sector is also displayed in the in the search results window. This list sector provides a listing of the search results items included in a user-selected category/classification or subset of the tree. More particularly, prior to the user selecting a top level category of the tree, all of the search results are made available for display and as many of the search results items that will fit into the space allotted to the list sector are displayed. When the user selects a subset in the tree, only those search results associated with the selected portion are displayed. In the case that the number of search result items made available for display is too large for all of them to be displayed in the space allotted to the list sector, the user can scroll thought the listing to bring search results items hidden from view due to the space limitation into view. In one embodiment this is accomplish using a graphic scroll bar displayed adjacent the list sector.

It is noted that as the user causes the various levels of the tree to be displayed, the previously displayed levels remain in view. In this way, the user can see the path taken from the top level category to the current lowest level. This aids in refining the search results.

It is further noted that whenever a level of the tree is displayed that has subsets of the search result items clustered into a series of ranges or involving type classifications, the number of search results items associated with each subset is displayed adjacent to it. In one embodiment a subset that does not have any search results items associated with it is displayed with a zero. In another embodiment, these empty subsets are not displayed in the tree. The latter embodiment has the advantage of simplifying the tree and making it easier for the user to refine the results.

A search results counter can also be displayed in the search results window. This counter indicates the total number of search results items included in the currently selected portion of the tree.

In addition to the just described benefits, other advantages of the present invention will become apparent from the detailed description which follows hereinafter when taken in conjunction with the drawing figures which accompany it.

### DESCRIPTION OF THE DRAWINGS

The specific features, aspects, and advantages of the present invention will become better understood with regard to the following description, appended claims, and accompanying drawings where:

FIG. 1 is a diagram depicting a general purpose computing device constituting an exemplary system for implementing the present invention.

FIG. 2 shows a search results window layout according to the present invention employing a how/what tree format and a search results list, where an example of the top level of the tree is displayed.

FIG. 3 shows the search results window layout of FIG. 2, where each of the top level categories of the tree have been expanded to show a second level.

FIG. 4 shows the search results window layout of FIG. 2, where the “Facets” category of the tree have been expanded to show its second level, and where the “Web Pages” subset of this second level has been selected.

FIG. 5 shows the search results window layout of FIG. 4, where the Web Pages” subset of the second level is expanded to show a third level of this branch of the tree which in the example shown involves a list of classifications representing how the search results associated with the Web Pages subset can be further refined.

FIG. 6 shows the search results window layout of FIG. 5, where the “Page Url” classification of the “Web Page” subset is expanded to show a fourth level of this branch of the tree, which in the example shown involves a list of subsets clustered in alphanumeric order.

### DETAILED DESCRIPTION OF THE PREFERRED EMBODIMENTS

In the following description of the preferred embodiments of the present invention, reference is made to the accompanying drawings which form a part hereof, and in which is shown by way of illustration specific embodiments in which the invention may be practiced. It is understood that other embodiments may be utilized and structural changes may be made without departing from the scope of the present invention.

1.0 The Computing Environment

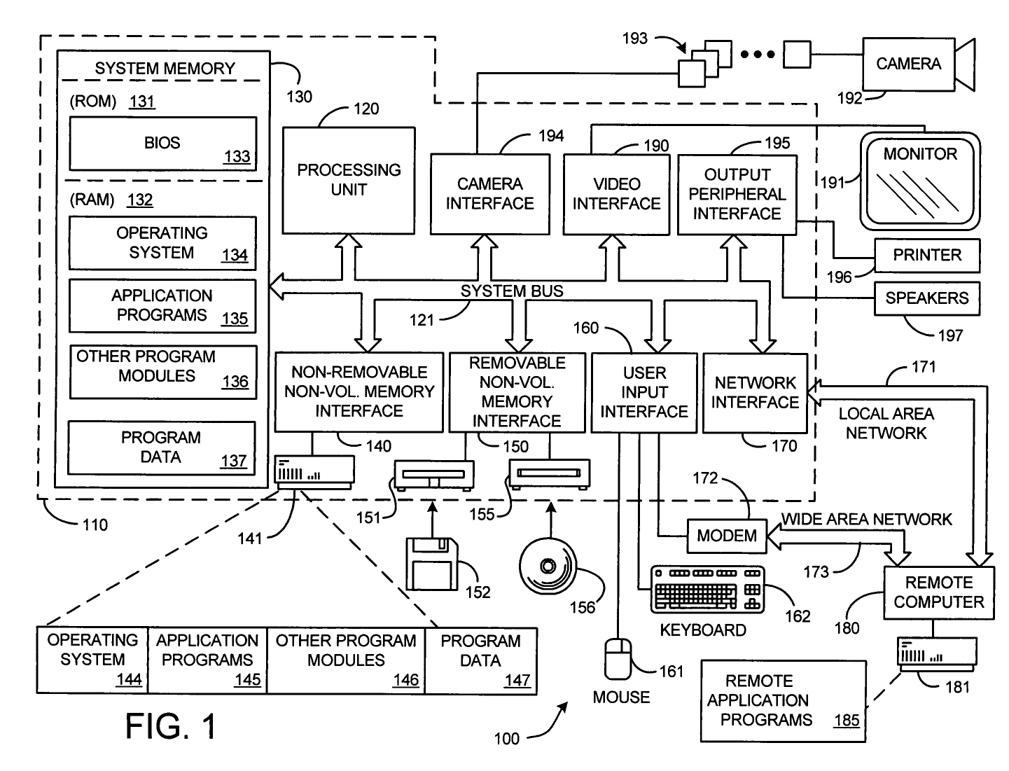

Before providing a description of the preferred embodiments of the present invention, a brief, general description of a suitable computing environment in which the invention may be implemented will be described. FIG. 1 illustrates an example of a suitable computing system environment 100.

The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. Of particular significance to the present invention, a camera 163 (such as a digital/electronic still or video camera, or film/photographic scanner) capable of capturing a sequence of images 164 can also be included as an input device to the personal computer 110. Further, while just one camera is depicted, multiple cameras could be included as input devices to the personal computer 110. The images 164 from the one or more cameras are input into the computer 110 via an appropriate camera interface 165. This interface 165 is connected to the system bus 121, thereby allowing the images to be routed to and stored in the RAM 132, or one of the other data storage devices associated with the computer 110. However, it is noted that image data can be input into the computer 110 from any of the aforementioned computer-readable media as well, without requiring the use of the camera 163.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

2.0 The Search Results Presentation System and Process

The exemplary operating environment having now been discussed, the remaining part of this description section will be devoted to a description of the program modules embodying the invention. Generally, the system and process according to the present invention involves providing a user interface that displays the results of a standard electronic search, such as a database search, in a manner that allows the user to visualize the results graphically, rather than just displaying a list of the items found. In addition, the user is given the ability to interact with the displayed results in order to refine them. In regard to this interaction with the interface, any convention method of selection could be implemented to allow the user to select functional features of the interface window. In tested versions of the present system and process, two modes of selection were implemented—namely standard single click and double click selection modes. For example, if the user is employing a conventional mouse or touch pad as an input device, the screen cursor would be moved as usual with the device and placed over the icon, button or other indicator whose associated function the user wants to activate. The user then “clicks” a selection button on the device either once or twice, as needed to activate the desired function.

As indicated previously, the search results presentation system and process according to the present invention provides a visualization of the results of an electronic search. Accordingly, it is presumed that the user has performed a search via conventional means and that the search results, in the form of a list of items found, is available. The presentation system is then initiated. This can be accomplished by the user manually selecting the program to run, or it can be configured to run automatically anytime a search is performed.

Once the present presentation system and process is activated, the search results are presented in a search results window, which includes a multi-leveled tree. In general, the first level of this tree indicates how the search results may be filtered. The second level of the tree shows the subsets (i.e., what) that are available for a particular filter method. The third level again shows how the already filtered (by the second level) results may again be filtered. This hierarchy is then repeated with odd-numbered levels of the tree indicating how the results may be filtered, and even-numbered levels indicating what subsets are available. Accordingly, the foregoing tree format will be referred to herein as a “how/what” tree format.

The configuration and interactive functionality of the search results window will now be described in the sections to follow.

2.1 The Search Results Window

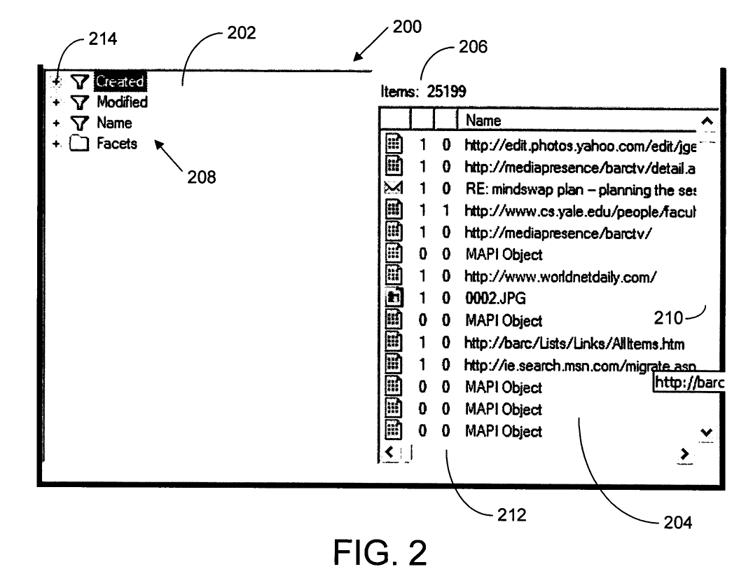

One embodiment of the layout of a search results window 200 employing the aforementioned how/what tree format, is shown in FIG. 2. In the depicted version of the window 200, a graphic data presentation sector 202 is displayed on the left side, and includes a region where the tree 208 is displayed. In the example shown in FIG. 2, the top level of the tree 208 is displayed. The aforementioned how/what format of the tree will be described in the next section.

In addition to the presentation sector 202, the window 200 also includes a search results list sector 204, which is disposed on the right side of the exemplary window 200 of FIG. 2. The search results list sector 204 displays a listing of all the search result items represented by the currently selected portion of the tree 208 displayed in the graphic data presentation sector 202. In the top level version of the tree shown in FIG. 2, all the search results are represented and so all the search items would be listed in the list sector 204. It is also noted that not all the items associated with the list may be able to be displayed in the room available in the list sector 204. However, the user can manually scroll through the list, moving up or down as desired, to display whatever item in the list the user desires. In the tested versions of the present system, this scrolling is performed using a graphic scroll bar 210. However, any other conventional scrolling method could alternately be made available for this purpose, such as using the arrow keys on a keyboard. It is also noted that the placement of the aforementioned graphic scroll bar 208 can be any desired. In the example shown in FIG. 2, the scroll bar 210 is displayed on the right side of the list sector 204. Further, each search item listed can include not only its name, but other known attributes as well. For example, each item could include information as to its size, the date it was created and/or last saved, and so on. If the space allotted to the list sector 204 is too small for all the information about each search result item to be displayed at one time, a scrolling means, such as the above-described graphic scroll bar, can be included for the user to employ in bringing hidden information into view. In the example shown in FIG. 2, such a scroll bar 212 is displayed at the bottom of the list sector 204.

A search results counter 206 is also included in the window 200, and is displayed just above the list sector 204. The search results counter 206 lists the total number of search result items represented by the currently selected portion of the tree displayed in the graphic data presentation sector 202. In the top level version of the tree shown in FIG. 2, all the search results are represented and so would be included in the count, which in the example is 25,199 items. This count will decrease as lower levels of the tree are selected to refine the search results, as will be described shortly.

It is noted that the layout of the foregoing sectors shown in FIG. 2 can be rearranged and reoriented as desired. For example, the graphic data presentation sector could be displayed on the right side, with the list sector being displayed on the left side. In another version of the search results window, the presentation and list sectors could be displayed one on top of the other. Similarly, the search result counter 206 can be displayed in any desired location within the window.

2.1.1 The How/What Tree Format

As indicated previously, FIG. 2 shows an example of the top level of the how/what tree representing ways (i.e., how) in which the entire search results may be refined. The top level categories can include any attribute known about all or at least some of the search result items. For example, in the embodiment of the search results window shown in FIG. 2, the categories are creation date, last-modified date, name, and “Facets”. Some additional categories not used in the example can include file size, and “folders belonging to . . . ”, among others. It is noted that while categories involving date, name and size relate to ranges (namely time, an alphanumeric sequence or number of bits), the Facet category is different. Facets refer to items that represent one type of a group of different types. For instance, in tested embodiments of the present system and process, Facets related to item type, such as a file, web page, message, and so on. The categories can be prescribed, or in an alternate version, the user could specify the desired top level categories. For example, the interface can be configured to allow the user to directly enter the desired category choices, or a list of categorization choices could be presented to the user to select from.

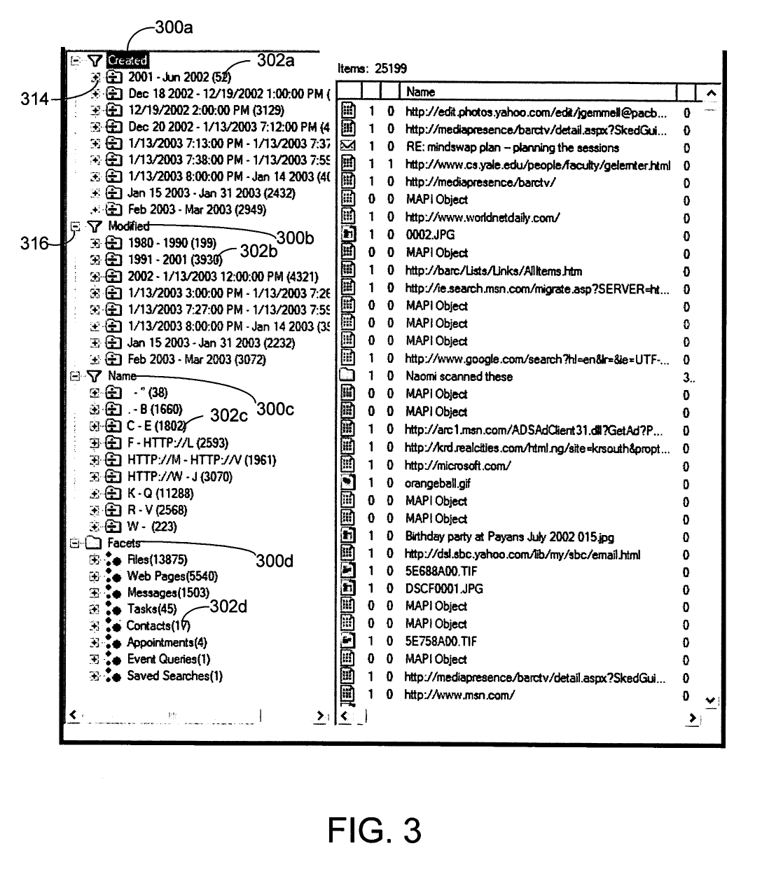

FIG. 3 shows the expansion of the top level categories 300 to reveal the second level “what” subsets 302. For the created and modified date categories 300a, 300b, the respective subsets 302a, 302b take the form of date ranges. For the names category 300c, the subsets 302c are alphanumeric ranges. And for the Facets category 300d, the subsets 302d are different item types. In all cases, the number of items in the subset is indicated. Essentially, the subsets 302 represent a clustering of the search results data. This clustering can be done via any conventional method. For example, in the case of dates, the clustering could be done via a set of prescribed date ranges. These ranges could be made equal such that each represents the same period of time (e.g., months, days, hours, and so on), or the ranges could be skewed such that some cover longer periods of time (e.g., the ranges associated with older dates are longer than those associated with newer dates). A similar clustering can be done with the alphanumeric segmentation of the name category search results data. For example, each subset could cover one letter or character, or prescribed range of letters and characters that could be equal in length or vary. In cases where size is the attribute involved, the search results could be clustered as described above into size ranges. Other methods of clustering might involve making each subset be associated with the same number of search result item. Further, more complex clustering algorithms, such as k-means, could also be employed to cluster the data.

As seen in the exemplary window of FIGS. 2 and 3, each top level category and each subset initially has a boxed plus sign icon 214, 314 displayed adjacent to it. The user selects these icons to expand the top level categories to revel the subsets associated therewith and similarly selects the plus icon to expand the subsets as will be described shortly. Once a category or subset has been expanded, the plus icon changes to a boxed minus sign icon 316. For example, each of the expanded top level categories depicted in FIG. 3 have minus sign icons 316 displayed adjacent to them. The user selects a minus sign icon 316 to contract the category or subset. In other words, the subsets associated with an expanded category or subset are no longer displayed, and just the category or subset itself is displayed along with the aforementioned plus sign icon 214, 314. The foregoing expansion & contraction of the tree is advantageous in that the user can view several levels at once to see what “path” was taken. This will assist the user in refining the search results.

2.1.2 Refining the Search Results

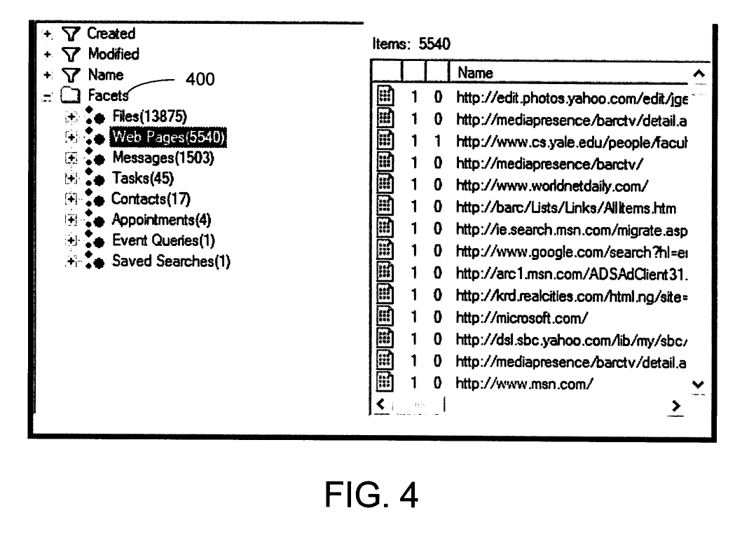

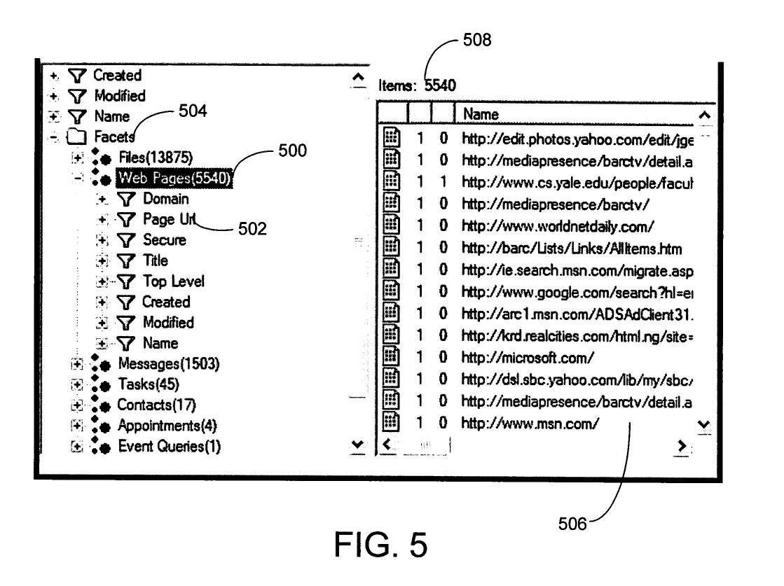

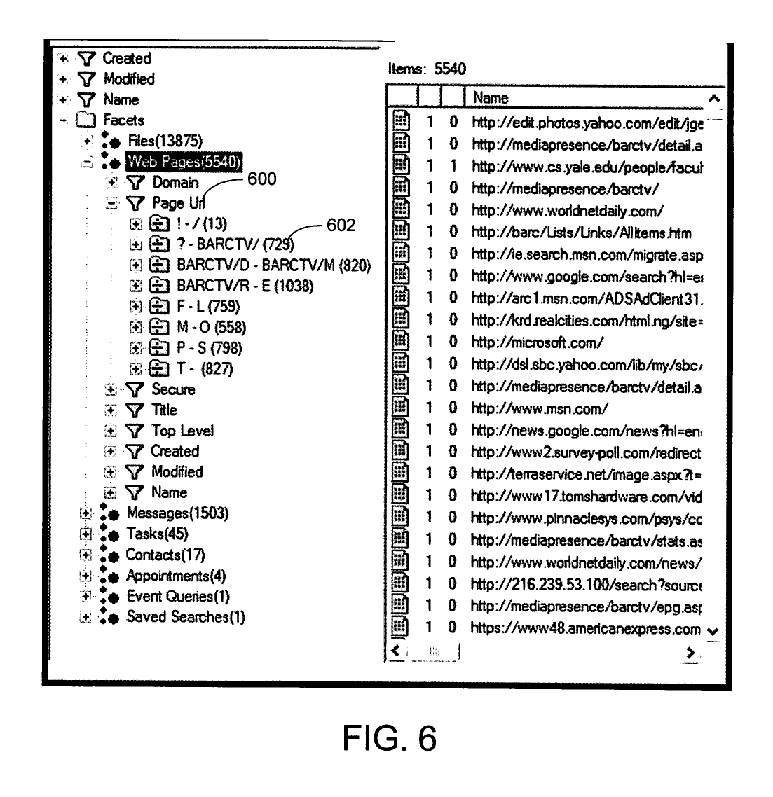

It is noted that all the top level categories are expanded in FIG. 3. This was done to better explain the expansion and contraction process. While a user could expand multiple categories or related subsets, more typically the user would be engaged in refining the search results and so would expand just one top level category and then one of the subsets and so on until the particular subset of the search results that the user is interested in is identified. An example of this progression is illustrated in FIGS. 4-6. FIG. 4 shows the top level Facet category 400 was expanded by the user. In FIG. 5, it is shown that the user has expanded one of the Facet subsets—namely the “Web Page” subset 500. As a result, a list of ways 502 to classify the search results related only to web pages is displayed. More particularly, the expansion shown in FIG. 5 represents a third level expansion, which as described previously displays subsets that once again indicate “how” the search results may be additionally refined. In the example shown in FIG. 5, the third level how subsets 502 allow the user to refine the search results associated with web pages by name, creation date or modified date, and also in ways unique to web pages, e.g. by domain name. It is noted that that web-page specific choices could have been shown at the top level. However, in tested embodiments it was decided to reduce the number of selections at each level that the user must select from, so as to simplify the selection process. This latter scheme is reflected in the example shown in FIG. 5. The refining process can continue with the user selecting one of the web page classifications 502 to reveal the next “what” selections are available. For example, referring to FIG. 6, the expansion of 4^{th} level under “page URL” 600 is shown. This expansion results in a list of what page URL subsets 602 are available for selection so the user can take the next step in the refining process, if desired. More particularly, a list of the URLs associated with the web pages in the search results are displayed, which have been clustered into alphanumeric ranges.

Like the top level “how” categories, the lower level “how” subsets can include any attribute known about all or at least some of the search result items. For example, in the embodiment of the search results window shown in FIG. 5, the subsets 502 are web pages classified by domains, page URLs, secure pages, title, top level pages, as well as the creation date, modified date and name classifications. These lower level classifications can be prescribed, or user-specified, as with the top level categories. Here again, in the case of the classifications being user specified, the interface can be configured to allow the user to directly enter the desired category choices or a list of categorization choices could be presented to the user to select from. In the case where a top level category or lower level classification does not have any search result items associated with it, in one embodiment of the present system and process, the how/what tree is simplified by not displaying the category or classification label. In this way the minimum number of categories and classifications are displayed thereby making the refining process easier for the user. Additionally, this allows a master set of categories and classification to be employed, rather than having to specify separate ones for each “how” level. For example, under the web page “what listing”, a classification pertaining to image files (such as the manufacturer of the camera used to capture the image) would never be displayed, since no web pages would appear under such a choice. Similarly, if a subset in a “what” level does not have any search results associated with it, in one embodiment, the subset label would not be displayed. In an alternated embodiment, the label would be displayed, but with an adjacent zero to indicate there are not search results associated with the subset.

In one embodiment of the present search results presentation system and process, the search results can be refined in a manner different from the foregoing method of expanding and contracting the how/what tree. This additional method involves the user selecting the category/classification and subset labels. This has several effects. First, the search results are restricted to just those associated with the selected category/classification or subset. Accordingly, the list of search result items displayed in the list sector includes only those items in the selected category/classification or subset. In addition, the tree automatically expands to show the level along the branch associated with the selected category/classification or subset, without the user having to select the plus sign icon. An example of the selection method is shown in FIG. 5, where the user has selected the “Web Pages” subset 500 of the Facets category 504, thereby restricting the search results displayed in the list sector 506 to just web pages. In addition, note that the search results item counter 508 reflects the number of web pages in the search results, which reduces the number of search results items from the original 25,199 shown in FIG. 2 to just the 5540 shown in FIG. 5. It is noted that the user could employ the expansion and contraction refining method described above to some point and then switch to the selection technique if desired, or vice versa.

The refining process can theoretically continue until only one search result item is included in the selected subset. However, some practical limit can also be established. For example, when the number of search result items associated with a selected subset is such that all of them can be listed in the list sector, the refining process could be stopped.

The ultimate goal of the foregoing refining process is typically to find a particular item of interest. In this regard, once the user has refined the search results to the point where the item or items of interest are displayed in the list sector, then he or she can select an item in the list for further action consistent with the choice. For example, if the selected item is a file, it could be opened, or if the item is a web page URL, the user could be connected to that site.

2.2 Alternate Configurations

While the invention has been described in detail by specific reference to the foregoing embodiments thereof, it is understood that variations and modifications may be made without departing from the true spirit and scope of the invention. For example, while the search results windows has been described as having a particular arrangement of sectors and other elements, these elements can be rearranged within the respective windows as desired. Further, it is noted that while full-featured versions of the interfaces were described, versions having fewer of these features are also possible and within the scope of the present invention.

1. In a computer system having a user interface including a display and a user interface selection device, a process for graphically displaying the results of an electronic search to a user on said display via an interactive search results window in which the user views and refines search results items displayed, comprising process actions for:
displaying a multi-leveled tree in a graphic data presentation sector of the search results window, comprising,
displaying a top level of the tree comprising a plurality of categories representing how the search results can be grouped, and
displaying, in response to a user command to do so, a second level of the tree for one or more of the top level categories, wherein the second level comprises one or more subsets representing the search results grouped via the top level category divided into smaller groups; and
displaying a list sector in the search results window which displays a listing of all the search results items included in a user-selected category or subset of the tree which will fit into the space allotted to the list sector.

2. The process of claim 1, wherein the process action of displaying a second level of the tree comprising one or more subsets representing the search results grouped via the associated top level category divided into smaller groups, comprises an action of clustering the top level category search results items into a series of ranges whenever appropriate for the type of items.

3. The process of claim 2, wherein the top level category under consideration categorized the search results by date, and wherein the process action of clustering the top level category search results items into a series of ranges appropriate for the items, comprises clustering the items into a series of date ranges.

4. The process of claim 2, wherein the top level category under consideration categorized the search results by name, and wherein the process action of clustering the top level category search results items into a series of ranges appropriate for the items, comprises clustering the items into a series of alphanumeric ranges based on a first symbol of the name of the search results item.

5. The process of claim 2, further comprising a process action for displaying, in response to a user command to do so, another level comprising ways in which the search results associated with an immediately preceding level of a branch of the tree can be classified, whenever said search results in the immediately preceding level of a branch of the tree are grouped in ranges appropriate to the type of search results.

6. The process of claim 5, wherein the search results classifications are specified by the user.

7. The process of claim 6, further comprising a process action of displaying to the user a list of search results classifications, wherein the user specifies the classifications by selecting from the list.

8. The process of claim 5, further comprising a process action for displaying, in response to a user command to do so, another level comprising one or more subsets representing the search results as grouped in an immediately preceding level of a branch of the tree divided into smaller groups each representing a range of the search results, whenever said search results in the immediately preceding level of the branch of the tree are identified via classifications appropriate to the type of search results.

9. The process of claim 8, wherein the process actions for displaying levels of the tree comprises an action of leaving previously displayed levels in view so that the use can see the path taken from the top level category to the lowest level displayed.

10. The process of claim 8, wherein the process actions of displaying a subset of the search results at any level comprise an action of displaying the number of search results items associated with the subset adjacent thereto.

11. The process of claim 10, wherein the process action of displaying the number of search results items associated with a subset adjacent thereto, comprises an action of displaying a zero for any subset not having any search results associated therewith.

12. The process of claim 8, wherein the process actions of displaying subsets of the search results at any level comprise an action of not displaying a subset whenever there are no search results items associated with it.

13. The process of claim 1, wherein the plurality of categories comprise a category representing the grouping of the search results by types, wherein each search result item applicable to this category is one of a predefined set of said types, and wherein the process action of displaying a second level of the tree comprising one or more subsets representing the search results grouped via the associated top level category divided into smaller groups, comprises an action of dividing the search results into type classifications.

14. The process of claim 13, further comprising a process action for displaying, in response to a user command to do so, a third level comprising one or more subsets representing the search results identified in an immediately preceding level of a branch of the tree by ways in which the search results of the branch can be further classified.

15. The process of claim 14, further comprising a process action for displaying, in response to a user command to do so, another level comprising one or more subsets representing the search results as grouped in an immediately preceding level of a branch of the tree divided into smaller groups each representing a range of the search results as determined by clustering the search results associated with the immediately preceding level, whenever said search results in the immediately preceding level of a branch of the tree are identified according to classifications appropriate to the type of search results.

16. The process of claim 15, further comprising a process action for displaying, in response to a user command to do so, another level representing the search results identified in an immediately preceding level of a branch of the tree by ways in which the search results of the branch can be further classified, whenever said search results in the immediately preceding level of the branch of the tree are grouped in ranges appropriate to the type of search results.

17. The process of claim 16, wherein the search results classifications are specified by the user.

18. The process of claim 17, further comprising a process action of displaying to the user a list of search results classifications, wherein the user specifies the classifications by selecting from the list.

19. The process of claim 16, wherein the process actions of displaying levels of the tree comprises and action of leaving previously displayed levels in view so that the use can see the path taken from the top level category to the lowest level displayed.

20. The process of claim 16, wherein the process actions of displaying a subset of the search results at any level grouped in ranges comprise an action of displaying the number of search results items associated with the subset adjacent thereto.

21. The process of claim 20, wherein the process action of displaying the number of search results items associated with a subset adjacent thereto, comprises an action of displaying a zero for any subset not having any search results associated therewith.

22. The process of claim 16, wherein the process actions of displaying subsets of the search results at any level comprise an action of not displaying a subset whenever there are no search results items associated with it.

23. The process of claim 1, wherein the process action of displaying the list sector in the search results window, comprises an action of, prior to the user selecting a category or subset of the tree, making available for display all of the search results and displaying as many of the search results items that will fit into the space allotted to the list sector in the search results window.

24. The process of claim 23, wherein the number of search result items made available for display is too large for all of them to be displayed in the space allotted to the list sector, and wherein the search results window further comprises a graphic scroll bar displayed adjacent the list sector which the user employs to bring search results items hidden from view due to the space limitation into view.

25. The process of claim 1, wherein the number of search result items included in the user-selected category or subset of the tree is too large for all of them to be displayed in the space allotted to the list sector in the search results window, and wherein the search results window further comprises a graphic scroll bar displayed adjacent the list sector which the user employs to bring search results items hidden from view due to the space limitation into view.

26. The process of claim 1, wherein the search results categories are specified by the user.

27. The process of claim 26, further comprising a process action of displaying to the user a list of search results categories, wherein the user specifies the categories by selecting from the list.

28. The process of claim 1, further comprising displaying a search results counter in the search results window which displays the total number of search results items prior to the user selecting a category or subset of the tree and which displays the number of search results items included in a user-selected category or subset of the tree after said selection is made.

29. An interactive search results presentation system, comprising:
a general purpose computing device comprising a display and a user interface selection device; and
a computer program comprising program modules executable by the computing device, wherein the computing device is directed by the program modules of the computer program to graphically display the results of an electronic search to a user on said display via a search results window, said search results window comprising,
a multi-leveled tree displayed in a graphic data presentation sector of the search results window, said tree comprising,
a top level comprising a plurality of categories representing how the search results can be grouped, and
a second level of one or more of the top level categories, wherein the second level comprises one or more subsets representing the search results grouped via the top level category divided into ranges, and wherein each second level is displayed in response to a separate user command to do so.

30. The system of claim 29, wherein the plurality of categories comprise known attributes of the search results.

31. The system of claim 30, wherein the plurality of categories comprises at least two of (i) the date a search results item was created, (ii) a date a search results item was last modified, (iii) a name of the search results item, (iv) a file size of a search results item.

32. The system of claim 30, wherein the plurality of categories comprise a category representing the search results grouped by a date associated therewith, and wherein the one or more subsets representing the search results grouped via date comprises the search results divided into date ranges.

33. The system of claim 30, wherein the plurality of categories comprise a category representing the search results grouped by name, and wherein the one or more subsets representing the search results grouped by name comprises the search results divided into alphanumeric ranges based on a first symbol of the name of the search results item.

34. The system of claim 30, wherein the plurality of categories comprise a category representing the search results grouped by file size, and wherein the one or more subsets representing the search results grouped by file size comprises the search results divided into size ranges.

35. The system of claim 30, wherein the tree further comprises another level, which is displayed in response to a user command to do so, and which comprises ways in which the search results associated with an immediately preceding level of a branch of the tree can be classified, whenever said search results in the immediately preceding level of a branch of the tree are grouped in ranges appropriate to the type of search results.

36. The system of claim 35, wherein the tree further comprises another level which is displayed in response to a user command to do so, and which comprises one or more subsets representing the search results as grouped in an immediately preceding level of a branch of the tree divided into smaller groups each representing a range of the search results, whenever said search results in the immediately preceding level of said branch of the tree are identified via classifications appropriate to the type of search results.

37. The system of claim 30, wherein the plurality of categories comprise a category representing the grouping of the search results by types, wherein each search result item applicable to this category is one of a predefined set of said types, and wherein said tree further comprises a second level associated with the type category which is displayed in response to a user command to do so and which comprises one or more subsets representing the search results divided into type classifications.

38. The system of claim 37, wherein the tree further comprises a third level, which is displayed in response to a user command to do so, and which comprises one or more subsets representing the search results identified in an immediately preceding level of a branch of the tree by ways in which the search results of the branch can be further classified.

39. The system of claim 38, wherein the tree further comprises another level, which is displayed in response to a user command to do so, and which comprises one or more subsets representing the search results as grouped in an immediately preceding level of a branch of the tree divided into smaller groups each representing a range of the search results as determined by clustering the search results associated with the immediately preceding level, whenever said search results in the immediately preceding level of the branch of the tree are identified according to classifications appropriate to the type of search results.

40. The system of claim 39, wherein the tree further comprises another level, which is displayed in response to a user command to do so, and which comprises one or more subsets representing the search results identified in an immediately preceding level of a branch of the tree by ways in which the search results of the branch can be further classified, whenever said search results in the immediately preceding level of the branch of the tree are grouped in ranges appropriate to the type of search results.

41. The system of claim 29, further comprising a program module for displaying a list sector in the search results window which displays a listing of search results items included in a user-selected category or subset of the tree.

42. A computer-readable medium having computer-executable instructions for graphically displaying the results of a search to a user on a display device via a search results window, said computer-executable instructions comprising:
displaying a multi-leveled tree in the search results window comprising alternating hierarchical levels, the odd numbers of which comprise ways in which all or a selected portion of the search results can be grouped, and the even numbers of which comprise one or more subsets representing the search results under consideration in the immediately preceding level divided into smaller groups; and
displaying a listing of search results items of all or the selected portion of the search results in the search results window.
